(19) United States
(12) Patent Application Publication
(10) Pub. No.: US 2007/0000902 A1
(43) Pub. Date: Jan. 4, 2007

(54) Heating assembly comprising a ptc element, in particular for a motor vehicle

(76) Inventors: Michel Brun, Rustenhard (FR); Christophe Schmittheisler, Epfig (FR); Pascal Miss, Selestat (FR); Maxime Mundel, Pfaffenheim (FR); Mathieu Mougey, Ensisheim (FR)

Correspondence Address: FOLEY AND LARDNER LLP;SUITE 500, 3000 K STREET NW, WASHINGTON, DC, 20007, US

(21) Appl. No.: 10/574,543

(22) PCT Filed: Sep. 15, 2004
(86) PCT No.: PCT/EP04/10328

§ 371 Date: Aug. 15, 2006

(30) Foreign Application Priority Data
Oct. 7, 2003 (EP) 03292474.8

(51) Int. Cl. H05B 3/42; H05B 1/00

(52) U.S. Cl. 219/242

(57) ABSTRACT

The invention relates to a heating assembly comprising at least one PTC element, in particular for a motor vehicle. According to the invention, the PTC element (2) is positioned between metal sheets (3, 4), which are used to make electrical contact, said sheets (3, 4) and the PTC element (2) are bonded by means of an adhesive (5) and the adhesive (5) has a minimum specific electrical resistance of 50 ohms×cm and a maximum specific electrical resistance of 500 ohms×cm. In addition, solder can be used as an alternative to the adhesive (5).

The invention relates to a heating assembly with a PTC element, in particular for a motor vehicle, according to the precharacterizing clause of claim 1.

DE 101 44 757 A1 discloses a heating assembly with a PTC element for passenger vehicles, a supplementary heating system being provided, having a heating element through which heating air flows during operation of the supplementary heating system and having at least one air outlet opening in the foot region of a passenger compartment, to which the heating air is conducted. To allow a vertical temperature stratification that is also comfortable in particular for seats at the rear to be produced in the passenger compartment in a flexible way, the heating element takes the form of an electrical PTC element, which is arranged directly at the air outlet opening in the foot region. A supplementary heater of this type still leaves something to be desired. According to one disclosed exemplary embodiment, a PTC element in the form of a number of heating honeycombs is arranged in a plastic frame (not described in any more detail), which surrounds the air outlet opening.

The attachment of contact plates to PTC elements conventionally takes place by means of an adhesive, insulating adhesives with a resistivity of over 10,000 ohms×cm or conducting adhesives with a resistivity of under 10 ohms×cm being used—depending on the application. Such bonds between the contact plate and the PTC element leave something to be desired.

The object of the invention is to provide an improved heating assembly with a PTC element.

This object is achieved by a heating assembly with a PTC element having the features of claim 1. Advantageous refinements are the subject of the subclaims.

According to the invention, a heating assembly with at least one PTC element is provided, the PTC element being arranged between contact plates which serve for making electrical connection, the contact plates and the PTC element being bonded by means of an adhesive which has a resistivity of at least 50 ohms×cm and at most 500 ohms×cm, preferably of at least 80 ohms×cm and at most 150 ohms×cm, in particular of 100 ohms×cm+/−10%.

Allowance for heating and safety aspects is made at the same time if an adhesive with a certain resistivity, in particular an adhesive with a resistivity of 50 to 500 ohms×cm, is chosen, the PTC elements being bonded to contact plates by this electrically conducting adhesive. The resistivity is to be chosen here on the one hand such that the risk of a short-circuit between the contact plates is avoided. On the other hand, the resistivity is to be chosen such that, in the event of the heating assembly being damaged as a consequence of aging, the adhesive layer can undergo enforced relaxation, averting direct contact between the PTC element and the contact plates, but the adhesive layer having adequate electrical conductivity to maintain the heating function should this occur. In this case, the adhesive layer has an additional electrical resistance and displays acceptable heating output. The advantage of the invention is that in this case the heating function is not disturbed. The aforementioned range for the resistivity has been found to be that which is most suitable.

It is preferred for the layer thickness of the adhesive between the PTC element and a contact plate before enforced relaxation to be negligible and after enforced relaxation to be at most 0.02 μm, in particular 0.01 μm+/−10%.

Instead of an adhesive, a solder with a corresponding resistivity may also be used.

The invention is explained in detail below on the basis of an exemplary embodiment with reference to the drawing, in which:

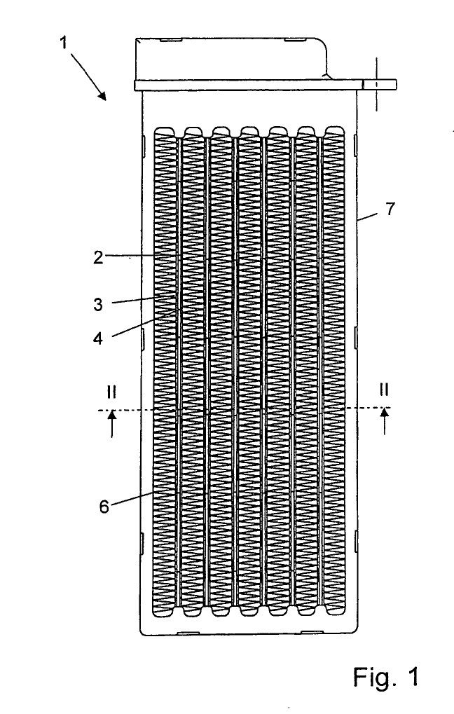

FIG. 1 shows a view of a heating assembly according to the invention,

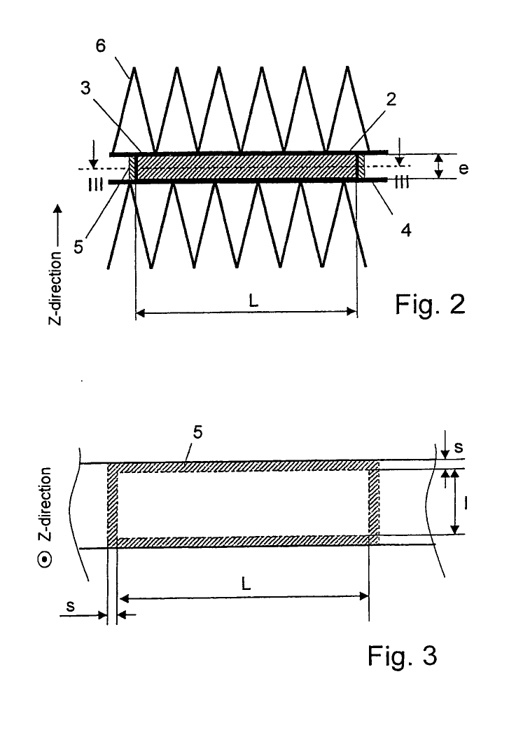

FIG. 2 shows an enlarged section through the heating assembly from FIG. 1 along the line II-II in FIG. 1,

FIG. 3 shows a section along the line III-III in FIG. 2,

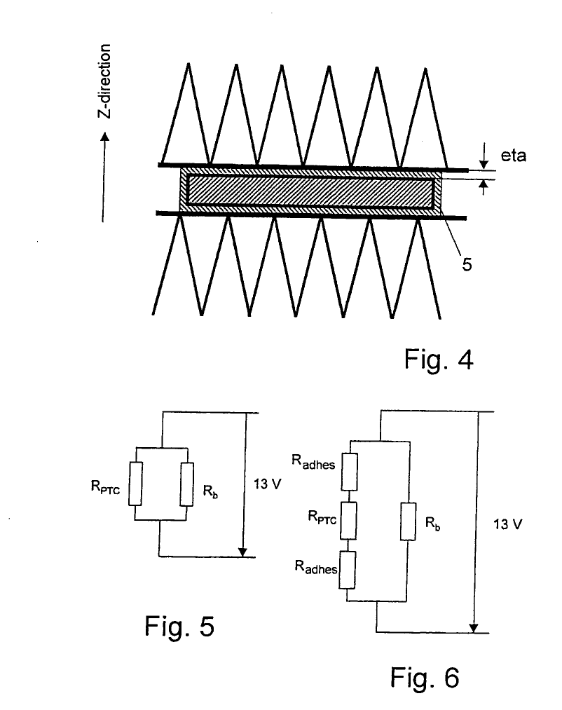

FIG. 4 shows a representation corresponding to FIG. 2 after enforced relaxation,

FIG. 5 shows an equivalent circuit diagram which illustrates the resistances, and

FIG. 6 shows an equivalent diagram corresponding to FIG. 5 which illustrates the resistances after enforced relaxation.

In the case of a PTC heating assembly 1 with ceramic PTC elements, a PTC element 2 is respectively bonded in place between two contact plates 3 (positive terminal) and 4 (negative terminal) that are arranged parallel to each other, in the present case by means of an adhesive 5 which has a resistivity of approximately 100 ohms×cm. Corrugated ribs 6 are attached by means of a corresponding adhesive bond on those sides of the contact plates 3 and 4 which in each case lie opposite the PTC element 2, and a respective further contact plate 3 and 4 is attached to said corrugated ribs, likewise by means of a corresponding adhesive bond. Arranged around the assembly described above is a plastic frame 7. The flow direction of the air is in the viewing direction in the case of FIG. 1.

Hereafter, the length of a PTC element 2 is denoted by L, in the present case 035 mm, the width of the PTC element 2 by, in the present case 8 mm, and the thickness of the PTC element 2 by e, in the present case 1.4 mm. The average thickness of the adhesive layer between the surface of the PTC element 2 and a contact plate 3 or 4 is denoted by eta, in the present case 0.01 μm. The width of the adhesive around the PTC element 2 between the contact plates 3 and 4 is denoted by s and in the present case is 1 mm.

The voltage between the contact plates 3 and 4 is denoted by U and, according to the present exemplary embodiment, is 13 V, but may also be greater, for example 48 V.

The resistivity of the adhesive 5 is denoted by Rho_{adhes}, the resistance of the PTC element 2 by R_{PTC}, the resistance of the adhesive layer between the PTC element 2 and the contact plate 3 or 4 by R_{adhes}.

The output of the PTC element 2 is denoted by P_{PTC}, the output of the adhesive 5 between the contact plates 3 and 4 by P_{b}, the output of the PTC element 2 in connection with the adhesive 5 without enforced relaxation by P_{adhesion+PTC without enforced relaxation}, the output of the PTC element 2 in connection with the adhesive 5 with enforced relaxation by P_{adhesion+PTC after enforced relaxation}, the overall output by Pₜₒₜₐₗ.

Here, the resistance R_{adhes} of the adhesive 5 between the PTC element and a contact plate 3 or 4 and the resistance R_{b} of the adhesive 5 surrounding the PTC element 2 is obtained as follows:
R_{adhes}=Rho_{adhes}×eta/(L×l) (1)
R_{b}=Rho_{adhes}×e/(2(L+l)×s) (2)

Equivalent diagrams for the circuits of the resistances are represented in FIGS. 5 and 6.

The output P_{adhesion+PTC without enforced relaxation} and the output P_{adhesion+PTC after enforced relaxation} are obtained by
P_{adhesion+PTC without enforced relaxation}=U²/R_{PTC} (3)
P_{adhesion+PTC after enforced relaxation}=U²/(2R_{adhes}+R_{PTC}) (4)

To bring about optimum efficiency of the PTC element 2, the ratio P_{PTC}/P_{b} should be chosen to be as great as possible. Furthermore, however, the ratio of P_{adhesion+PTC without enforced relaxation}/P_{adhesion+PTC after enforced relaxation} should lie as close as possible to 1. In this case, the ratio of P_{PTC}/P_{b} lies in particular between about 4 and 40 and the ratio of P_{adhesion+PTC without enforced relaxation}/P_{adhesion+PTC after enforced relaxation} lies between about 1.2 and 1.02.

### LIST OF DESIGNATIONS

1 heating assembly
2 PTC element
3 contact plate
4 contact plate
5 adhesive
6 corrugated rib
7 plastic frame

1. A heating assembly with at least one PTC element, in particular for a motor vehicle, the PTC element being arranged between contact plates which serve for making electrical connection, the contact plates and the PTC element being bonded by means of an adhesive wherein the adhesive has a resistivity of at least 50 ohms×cm and at most 500 ohms×cm.

2. The heating assembly as claimed in claim 1, wherein the adhesive has a resistivity of at least 80 ohms×cm and at most 150 ohms×cm, in particular of 100 ohms×cm+/−10%.

3. The heating assembly as claimed in claim 1, wherein the layer thickness of the adhesive between the PTC element and a contact plate before enforced relaxation is negligible and after enforced relaxation is at most 0.02 μm, in particular 0.01 μm+/−10%.

4. A heating assembly with at least one PTC element, in particular for a motor vehicle, the PTC element being arranged between contact plates which serve for making electrical connection, the contact plates and the PTC element being bonded by means of a solder, wherein the solder has a resistivity of at least 50 ohms×cm and at most 500 ohms×cm.

5. The heating assembly as claimed in claim 4, wherein the solder has a resistivity of at least 80 ohms×cm and at most 150 ohms×cm, in particular of 100 ohms×cm+/−10%.

6. The heating assembly as claimed in claim 4, wherein the layer thickness of the solder between the PTC element and a contact plate before enforced relaxation is negligible and after enforced relaxation is at most 0.02 μm, in particular 0.01 μm+/−10%.

7. An adhesive or a solder for bonding between a ceramic PTC element and an electrically conducting contact plate characterized in that the adhesive (5) or the solder has a resistivity of at least 50 ohms×cm and at most 500 ohms×cm.

8. The heating assembly as claimed in claim 2, wherein the layer thickness of the adhesive between the PTC element and a contact plate before enforced relaxation is negligible and after enforced relaxation is at most 0.02 μm, in particular 0.01 μm±10%.

9. The heating assembly as claimed in claim 5, wherein the layer thickness of the solder between the PTC element and a contact plate before enforced relaxation is negligible and after enforced relaxation is at most 0.02 μm, in particular 0.01 μm±10%.
